(19) United States
(12) Patent Application Publication
(10) Pub. No.: US 2019/0351462 A1
(43) Pub. Date: Nov. 21, 2019

(54) BRUSH CLEANING APPARATUS

(71) Applicant: Lori Brockhoeft, Lakeland, FL (US)

(72) Inventor: Lori Brockhoeft, Lakeland, FL (US)

(21) Appl. No.: 16/192,560

(22) Filed: Nov. 15, 2018

Related U.S. Application Data
(60) Provisional application No. 62/588,388, filed on Nov. 19, 2017.

(51) Int. Cl. B08B 3/08; A46B 17/06

(52) U.S. Cl. CPC B08B 3/08; A46B 2200/1046; A46B 17/06

(57) ABSTRACT

A brush cleaning apparatus can include one or more side walls enclosing a base on all sides of the base. The brush cleaning apparatus can also include a first group of one or more first projections of a first height attached to the base inside an enclosure formed by the one or more side walls and a second group of one or more second projections of a second height attached to the base inside the enclosure formed by the one or more side walls. The brush cleaning apparatus can optionally include a third group of one or more third projections of a third height attached to the base inside the enclosure formed by the one or more side walls.

### RELATED APPLICATIONS

This application claims the benefit of U.S. Provisional Application No. 62/588,388, entitled “MAKEUP BRUSH CLEANING APPARATUS” and filed on Nov. 19, 2017, which is incorporated herein by reference in its entirety.

### TECHNICAL FIELD

Some implementations relate generally to a cleaning apparatus, and more particularly, to a brush cleaning apparatus, such as a makeup brush cleaning apparatus.

### BACKGROUND

Brush cleaning apparatus are commonly used to clean brushes such as makeup brushes and paint brushes. Conventional apparatus for cleaning brushes—e.g., makeup brushes—may be convenient for cleaning only brushes with bristles of a certain length. Such apparatus may be designed, for example, to clean brushes with either ¾ inch heads or ¼ inch heads but not both.

It may be desirable to provide a brush cleaning apparatus capable of cleaning brushes with different sized heads, for example, brushes with bristles of different lengths. Also, it may be desirable to provide a brush cleaning apparatus capable of cleaning brushes of different types. Some implementations were conceived in light of the above-mentioned needs, limitations, or problems, among other things.

### SUMMARY

Some implementations include a brush cleaning apparatus. The brush cleaning apparatus can include one or more side walls enclosing a base on all sides of the base. The apparatus can also include a first group of one or more first projections of a first height attached to the base inside an enclosure formed by the one or more side walls as well as a second group of one or more second projections of a second height attached to the base inside the enclosure formed by the one or more side walls. In some implementations, the one or more first projections extend in an upward direction from the base up to a height of ⅝ inch and the one or more second projections extend in an upward direction from the base up to a height of ⅛ inch.

The brush cleaning apparatus can also include a measuring apparatus. The measuring apparatus can be one or more of a measuring spoon or a scooping spoon. The one or more side walls and the base can be made of one or more of plastic, glass, ceramic, porcelain, metal, wood, stone, composite, synthetic, thermoplastic, rubber, textile, plant fiber, natural or man-made materials. The first projections and second projections can be made of one or more of plastic, glass, ceramic, porcelain, metal, wood, stone, composite, synthetic, thermoplastic, rubber, textile, plant fiber, natural or man-made materials. The side walls, the base, the first projections, and the second projections can form a single integrated unit without one or more joints, interfaces, connections, or attachments.

In some implementations, a brush cleaning apparatus can include one or more side walls enclosing a base on all sides of the base, wherein the base is formed at a pre-determined angle with respect to one or more of the one or more side walls. The apparatus can also include a first group of one or more first projections of a first height attached to the base inside an enclosure formed by the one or more side walls, a second group of one or more second projections of a second height attached to the base inside the enclosure formed by the one or more side walls, and a third group of one or more third projections of a third height attached to the base inside the enclosure formed by the one or more side walls. The one or more first projections extend in an upward direction from the base up to a height of ½ inch. The one or more second projections extend in an upward direction from the base up to a height of ¼ inch. The one or more third projections extend in an upward direction from the base up to a height of ⅛ inch.

The first projections, the second projections, and the third projections can be made of one or more of plastic, glass, ceramic, metal, porcelain, wood, stone, composite, synthetic, thermoplastic, rubber, textile, plant fiber, natural or man-made materials. The side walls, the base, the first projections, the second projections, and the third projections form a single integrated unit without one or more joints, interfaces, connections, or attachments. The brush cleaning apparatus can also include a measuring apparatus.

A method for cleaning brushes can include adding warm water and antibacterial soap to an enclosure of a brush cleaning apparatus, wherein the antibacterial soap is added using a measuring spoon, and wherein the enclosure comprises one or more side walls enclosing a base on all sides of the base along with a first group of one or more first projections of a first height and a second group of one or more second projections of a second height attached to and extending upwards from the base. The method can also include inserting a brush with one or more bristles into the warm water in the enclosure, moving the bristles of the brush against one of the one or more first projections or the one or more second projections in one of a pre-determined direction or a sequence, rinsing the bristles of the brush with the warm water, and drying the bristles of the brush. The bristles can be moved alternatingly in a first direction and a second direction opposite to the first direction. The bristles can also be swirled around within the enclosure in one or more of a clockwise direction or an anti-clockwise direction. The base can be formed at a pre-determined angle with respect to one or more of the one or more side walls of the enclosure.

### BRIEF DESCRIPTION OF THE DRAWINGS

FIG. 1 is a diagram showing a top perspective view of example brush cleaning apparatus in accordance with some implementations.

FIG. 2 is a diagram showing a side cutaway view of an example brush cleaning apparatus in accordance with some implementations.

FIG. 3 is a diagram showing a top cutaway view of an example brush cleaning apparatus in accordance with some implementations.

FIG. 4 is a diagram showing a side cutaway view of an example brush cleaning apparatus in accordance with some implementations.

### DETAILED DESCRIPTION

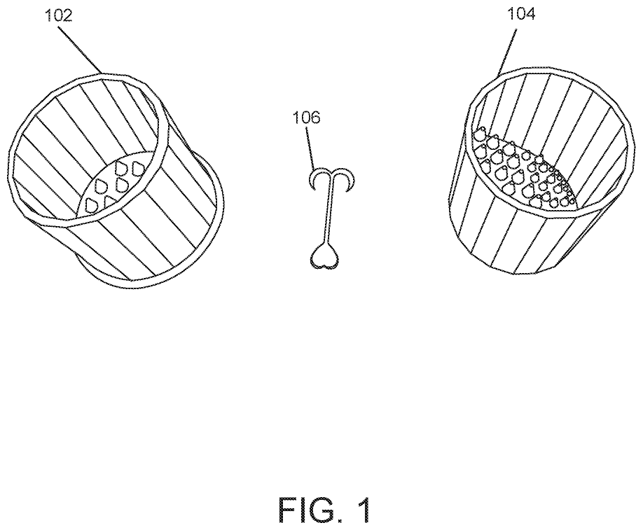

FIG. 1 is a diagram showing example brush cleaning apparatus in accordance with some implementations. A first embodiment 102 of the brush cleaning apparatus is configured to clean brushes having bristles that are substantially aligned with a longitudinal axis of the handle of the brush (e.g., makeup brushes with an arrangement of bristles such as that found in paint brushes).

A second embodiment 104 of the brush cleaning apparatus is configured to clean brushes having bristles that are aligned at an angle (e.g., about a 90-degree angle) to a longitudinal axis of the handle of the brush (e.g., makeup brushes with an arrangement of bristles such as that found in toothbrushes).

The brush cleaning apparatus of the first embodiment 102 or the second embodiment 104 can also include a measuring spoon 106 for measuring a pre-determined quantity of antibacterial soap. Also, 106 can be a scooping spoon for scooping the pre-determined quantity of the soap.

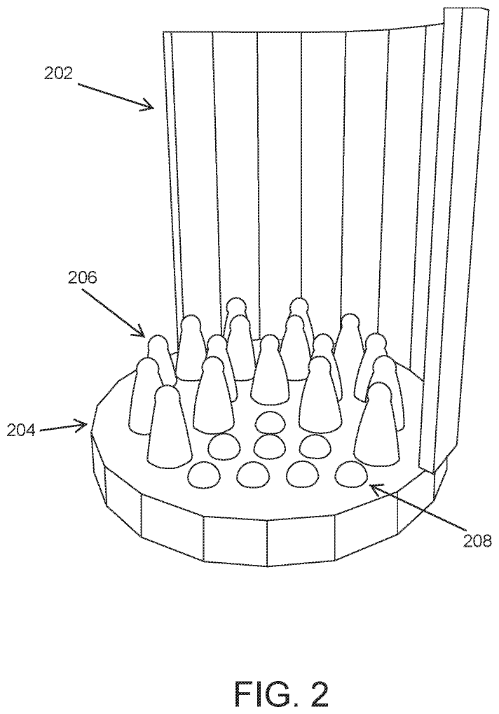

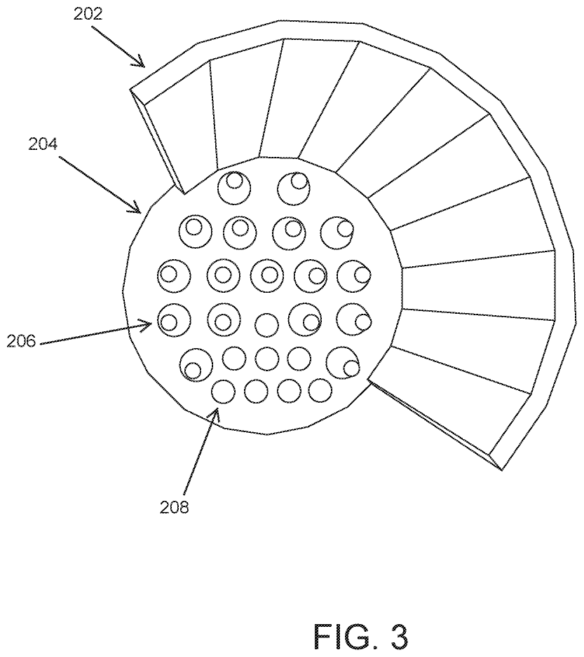

FIG. 2 and FIG. 3 are diagrams showing side cutaway views of example brush cleaning apparatus of the first embodiment 102 of brush cleaning apparatus in accordance with some implementations. The brush cleaning apparatus shown in FIG. 2 and FIG. 3 includes a side wall (e.g., a cylindrical side wall) 202, a base or bottom 204, a first group of prongs or projections 206 as well as a second group of prongs or projections 208 in the first embodiment 102.

The first group of prongs or projections 206 can include prongs or projections having a first height configured for cleaning larger brushes (e.g., makeup brushes with ¾ inch heads). For example, the prongs or projections in the first group of prongs or projections 206 can extend about ⅝ inch in an upward direction from the base or bottom 204 of the apparatus.

The second group of prongs or projections 208 can include prongs or projections having a second height configured for cleaning smaller brushes (e.g., makeup brushes with ¼ inch heads). For example, the prongs or projections in the second group of prongs or projections 208 can extend about ⅛ inch in an upward direction from the base or bottom 204 of the apparatus.

In some implementations, the brush cleaning apparatus can include about 17 prongs in the first group of prongs or projections 206 and about 8 prongs in the second group of projections or prongs 208.

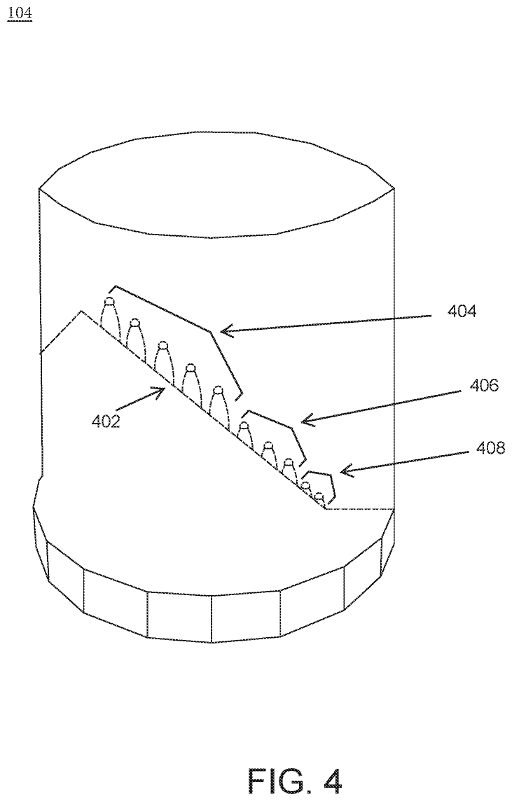

FIG. 4 is a diagram showing a side cutaway view of an example brush cleaning apparatus of the second embodiment 104 of brush cleaning apparatus in accordance with some implementations. The brush cleaning apparatus 104 includes an angled base or bottom 402 having an angle (e.g., about 30 degrees) with respect to a side wall (e.g., a cylindrical side wall), a first group of prongs or projections 404, a second group of prongs or projections 406, and a third group of prongs or projections 408. The first group of prongs/projections 404 can include prongs or projections having a first height (e.g., ½ inch). The second group of prongs/projections 406 can include prongs or projections having a second height (e.g., ¼ inch). The third group of prongs/projections 408 can include prongs or projections having a third height (e.g., ⅛ inch).

In some implementations, the brush cleaning apparatus can be about 3-½ inches tall (e.g., the side walls can be around 3-½ inches tall) and 3-¼ inches wide (e.g., the base or bottom can be around 3-¼ inches wide). The dimensions of the brush cleaning apparatus described herein are for illustration purposes only, not intended to be limiting, and the brush cleaning apparatus can be made of other dimensions depending on a contemplated implementation. The brush cleaning apparatus can be made from suitable material such as plastic, glass, ceramic, porcelain, metal, wood, stone, composite, synthetic, thermoplastic, rubber, textile, plant fiber, natural and/or man-made materials.

To clean brushes using the brush cleaning apparatus, the apparatus can be filled with warm water up to about half the height of the side walls. A predetermined or a required amount of soap (e.g., antibacterial soap) can be added to the warm water (e.g., the measuring or scooping spoon 106 supplied with the brush cleaning apparatus 102/104 can be used to measure and scoop an amount of antibacterial dish soap).

A brush (e.g., a makeup brush) can then be inserted into the warm water mixed with soap in the brush cleaning apparatus and can be gently swirled around within the soaped warm water over the first group of prongs or projections and/or the second group of prongs or projections, especially when used with the first embodiment (e.g., 102) of the brush cleaning apparatus.

Alternatively, the brush (e.g., a makeup brush), after being inserted into the warm water mixed with soap, can be gently brushed up and down the first group of prongs or projections and/or the second group of prongs or projections on the angled or slanted base or bottom, especially when used with the second embodiment (e.g., 104) of the brush cleaning apparatus.

The swirling motion or the up and down brushing motion can cause bristles of the brush to contact the first group of prongs or projections and/or the second group of prongs or projections, thereby enabling or helping clean the bristles of the brush. Once the bristles are clean, the brush can be rinsed with water and blotted dry. The bristles of the brush can be moved against the first group of prongs or projections and/or the second group of prongs or projections in any other predetermined direction or any other sequence of steps. For example, the bristles can be moved alternatingly in a first direction and a second direction opposite to the first direction. The bristles of the brush can, for example, also be swirled around in one or more of a clockwise direction or an anti-clockwise direction.

The shapes, forms, structures, materials, and sizes/dimensions of the brushes, the bristles, the side walls, the base or bottom, the measuring or scooping spoon, the first group of prongs or projections, the second group of prongs or projections, and the third group of projections/prongs described herein are for illustration purposes only, not intended to be limiting, and can take other shapes, forms, structures, materials, and/or sizes/dimensions depending on a contemplated implementation.

It is therefore apparent that there is provided, in accordance with the various implementations disclosed herein, a brush cleaning apparatus.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A brush cleaning apparatus comprising:
one or more side walls enclosing a base on all sides of the base;
a first group of one or more first projections of a first height attached to the base inside an enclosure formed by the one or more side walls; and
a second group of one or more second projections of a second height attached to the base inside the enclosure formed by the one or more side walls.

2. The brush cleaning apparatus of claim 1, wherein the one or more first projections extend in an upward direction from the base up to a height of ⅝ inch.

3. The brush cleaning apparatus of claim 1, wherein the one or more second projections extend in an upward direction from the base up to a height of ⅛ inch.

4. The brush cleaning apparatus of claim 1, further comprising a measuring apparatus.

5. The brush cleaning apparatus of claim 4, wherein the measuring apparatus is one or more of a measuring spoon or a scooping spoon.

6. The brush cleaning apparatus of claim 1, wherein the one or more side walls and the base are made of one or more of plastic, glass, ceramic, porcelain, metal, wood, stone, composite, synthetic, thermoplastic, rubber, textile, plant fiber, natural or man-made materials.

7. The brush cleaning apparatus of claim 1, wherein the first projections and the second projections are made of one or more of plastic, glass, ceramic, porcelain, metal, wood, stone, composite, synthetic, thermoplastic, rubber, textile, plant fiber, natural or man-made materials.

8. The brush cleaning apparatus of claim 1, wherein the side walls, the base, the first projections and the second projections form a single integrated unit without one or more joints, interfaces, connections, or attachments.

9. A brush cleaning apparatus comprising:
one or more side walls enclosing a base on all sides of the base, wherein the base is formed at a pre-determined angle with respect to one or more of the one or more side walls;
a first group of one or more first projections of a first height attached to the base inside an enclosure formed by the one or more side walls;
a second group of one or more second projections of a second height attached to the base inside the enclosure formed by the one or more side walls; and
a third group of one or more third projections of a third height attached to the base inside the enclosure formed by the one or more side walls.

10. The brush cleaning apparatus of claim 9, wherein the one or more first projections extend in an upward direction from the base up to a height of ½ inch.

11. The brush cleaning apparatus of claim 9, wherein the one or more second projections extend in an upward direction from the base up to a height of ¼ inch.

12. The brush cleaning apparatus of claim 9, wherein the one or more third projections extend in an upward direction from the base up to a height of ⅛ inch.

13. The brush cleaning apparatus of claim 1, further comprising a measuring apparatus.

14. The brush cleaning apparatus of claim 1, wherein the one or more side walls and the base are made of one or more of plastic, glass, ceramic, porcelain, metal, wood, stone, composite, synthetic, thermoplastic, rubber, textile, plant fiber, natural or man-made materials.

15. The brush cleaning apparatus of claim 1, wherein the first projections, the second projections and the third projections are made of one or more of plastic, glass, ceramic, metal, porcelain, wood, stone, composite, synthetic, thermoplastic, rubber, textile, plant fiber, natural or man-made materials.

16. The brush cleaning apparatus of claim 1, wherein the side walls, the base, the first projections, the second projections, and the third projections form a single integrated unit without one or more joints, interfaces, connections, or attachments.

17. A method for cleaning brushes, the method comprising:
adding warm water and antibacterial soap to an enclosure of a brush cleaning apparatus, wherein the antibacterial soap is added using a measuring spoon, and wherein the enclosure comprises one or more side walls enclosing a base on all sides of the base along with a first group of one or more first projections of a first height and a second group of one or more second projections of a second height attached to and extending upwards from the base;
inserting a brush with one or more bristles into the warm water in the enclosure;
moving the bristles of the brush against one of the one or more first projections or the one or more second projections in one of a pre-determined direction or a sequence;
rinsing the bristles of the brush with the warm water; and
drying the bristles of the brush.

18. The method for cleaning brushes of claim 17, wherein the bristles are moved alternatingly in a first direction and a second direction opposite to the first direction.

19. The method for cleaning brushes of claim 17, wherein the bristles are swirled around within the enclosure in one or more of a clockwise direction or an anti-clockwise direction.

20. The method for cleaning brushes of claim 17, wherein the base is formed at a pre-determined angle with respect to one or more of the one or more side walls of the enclosure.
